(19) United States
(12) Patent Application Publication
(10) Pub. No.: US 2021/0314524 A1
(43) Pub. Date: Oct. 7, 2021

(54) METHOD AND SYSTEM FOR TWO-STAGE DIALING FOR AUDIO AND VIDEO COMMUNICATIONS BASED ON IMS

(71) Applicant: Ankang Hongtian Science&Technology Incorporated Company, Ankang (CN)

(72) Inventor: Lihong HAO, Ankang (CN)

(21) Appl. No.: 17/013,608

(22) Filed: Sep. 6, 2020

(30) Foreign Application Priority Data
Apr. 2, 2020 (CN) 202010255003.5

(51) Int. Cl. H04N 7/14; G06K 9/00; H04L 29/06; G06N 3/08; G06F 21/31

(52) U.S. Cl. CPC H04N 7/147; G06K 9/00288; G06K 9/00255; G06F 21/31; H04L 65/1069; G06N 3/08; H04L 65/1016

(57) ABSTRACT

A method and a device for two-stage dialing for audio and video communications based on IMS. The call request sent from the user terminal is acquired, where the call request includes the target number that the user terminal dials on the IMS, and the target number is allocated by the IMS. The communications link is established between the user terminal and the IMS according to the target number. The operation navigation prompt is sent to the user terminal, and the service confirmation information of the two-stage dialing fed back from the user terminal according to the operation navigation prompt is received. The target number is dialed through the user terminal, and the service option selected by the user is confirmed by receiving the service confirmation information for the two-stage dialing fed back by the user terminal based on the operation navigation prompt.

### CROSS-REFERENCE TO RELATED APPLICATIONS

This application claims the benefit of priority from Chinese Patent Application No. 202010255003.5, filed on Apr. 2, 2020. The content of the aforementioned application, including any intervening amendments thereto, is incorporated herein by reference in its entirety.

### TECHNICAL FIELD

This application relates to intelligent communication identification, and more particularly to a method and a system for two-stage dialing for audio and video communications based on IP Multimedia Subsystem (IMS).

### BACKGROUND

Currently, people are greatly dependent on instant messaging in the daily life, due to the development of financial industry, economic and technological development and improvement of the living standard, in which two-stage dialing for communication is capable of facilitating the convenience of people's life. Traditional two-stage dialing communication is mainly applied for communication hotlines. Based on an interactive voice response (IVR) system, an audio communication link is established by determining the items selected by users through DTMF signals and transferring keys pressed by the user. Communication hotlines, which provide timely information consulting services for users by effectively integrating resources of hotline answerers, are widely used in enterprises, institutions and governments.

However, video communication and message interaction between hotline answerers and users cannot be realized through the two-stage dialing, which greatly limits the communication between users and hotline answerers. In this way, users cannot be remotely helped by the hotline answerers through visualized guidance. Therefore, when services should be provided based on intuitive understanding of the scene, the traditional two-stage dialing communication fails to allow the hotline answerer to provide remote and visualized guidance for the users.

### SUMMARY

The present disclosure aims to provide a method for two-stage dialing for audio and video communications based on IMS to overcome the defects in the prior art, in which the audio and video communication with hotline answerer is established based on the two-stage dialing.

To achieve the above object, the present disclosure provides a method for two-stage dialing for audio and video communications based on IMS, comprising:

acquiring a call request sent from a user terminal; wherein the call request comprises a target number that the user terminal dials based on the IMS;

establishing a communications link between the user terminal and the IMS; and sending an operation navigation prompt preset to the user terminal; and

receiving service confirmation information for the two-stage dialing fed back by the user terminal based on the operation navigation prompt; and establishing the audio and video communication between the IMS and the user terminal according to the service confirmation information.

In some embodiments, the method further comprises:

acquiring an IMS account and verification information;

checking the verification information and the IMS account according to a preset rule;

when the verification information matches the IMS account, generating a key file according to the verification information, the IMS account, and device information of the user terminal, and sending the key file to the user terminal, so that the user terminal activates the IMS account according to the key file, so as to perform network communication.

In some embodiments, the method further comprises:

acquiring a hotline number acquisition request sent from the user terminal through the IMS account; and

sending a preset hotline number list to the user terminal according to the hotline number acquisition request, wherein the hotline number list includes at least one target number.

In some embodiments, the step of sending the preset operation navigation prompt to the user terminal comprises:

determining a service type corresponding to the target number; and

searching the operation navigation prompt corresponding to the service type in a preset service navigation database, and sending the operation navigation prompt to the user terminal.

In some embodiments, the step of receiving service confirmation information for the two-stage dialing fed back by the user terminal based on the operation navigation prompt comprises:

receiving the service confirmation information sent from the user terminal, wherein the service confirmation information comprises selection for the two-stage dialing that a user makes based on the operation navigation prompt shown in the user terminal; and

determining a service option that the user selects according to the selection for the two-stage dialing.

In some embodiments, the step of establishing the audio and video communication between the IMS and the user terminal according to the service confirmation information comprises:

calling a communication interface corresponding to the service option; and

establishing the audio and video communication between the IMS and the user terminal based on the communication interface.

In some embodiments, the method further comprises:

acquiring a face image uploaded by the user terminal, wherein the face image is an image of a user's face collected by the user terminal;

inputting the face image into a preset face recognition model, wherein the preset face recognition model is a neural network model trained to convergence; and

acquiring user's identity information outputted by the preset face recognition model.

In some embodiments, the method further comprises:

comparing user's personal information with the user's identity information uploaded by the user terminal; and

when the user's personal information fails to match the user's identity information, issuing a preset user error warning.

In some embodiments, the method further comprises:

integrating the user's personal information and terminal information of the user terminal to obtain user error information; and

generating an error log corresponding to the user terminal based on the user error information, and saving the error log.

The present disclosure further provides a device for two-stage dialing for audio and video communications based on IMS, comprising:

an acquisition device, which is configured to acquire a call request sent from a user terminal, wherein the call request includes a target number that the user terminal dials based on the IMS;

a processor, which is configured to establish a communications link with the user terminal and send a preset operation navigation prompt to the user terminal; and

an execution device, which is configured to receive service confirmation information for the two-stage dialing returned from the user terminal according to the operation navigation prompt, and establish audio and video communications with the user terminal according to the service confirmation information.

The present invention has the following beneficial effects.

The call request sent from the user terminal is acquired, where the call request includes the target number that the user terminal dials on the IMS, and the target number is allocated by the IMS. The communication is established between the user terminal and the IMS according to the target number. The operation navigation prompt is sent to the user terminal, and the user terminal guides the user to perform the two-stage dialing, and the service confirmation information of the two-stage dialing fed back from the user terminal according to the operation navigation prompt is received, so as to confirm the service selected by the user. An audio and video communication is established between the IMS and the user terminal based on the service confirmation information, so that the video or message communication can be realized between the IMS and the user terminal based on the two-stage dialing, which effectively solves the problem that face-to-face communication is hard to be realized in online service.

### BRIEF DESCRIPTION OF THE DRAWINGS

The present invention will be described as follows with reference to the embodiments and the accompanying drawings, from which technical solutions and advantages of the present invention will become obvious and more understandable.

FIG. 1 is a flow chart of a method for two-stage dialing for audio and video communications based on IMS according to an embodiment of the present disclosure.

FIG. 2 is a flow chart of the step of checking an IMS account according to an embodiment of the present disclosure.

FIG. 3 is a flow chart of the step of acquiring a hotline number according to an embodiment of the present disclosure.

FIG. 4 is a flow chart of the step of generating service confirmation information according to an embodiment of the present disclosure.

FIG. 5 is a flow chart of the step of performing face recognition according to an embodiment of the present disclosure.

FIG. 6 is a flow chart of the step for identifying the user's identity information according to an embodiment of the present disclosure.

FIG. 7 is a flow chart of the step for generating an error log according to an embodiment of the present disclosure.

FIG. 8 schematically shows a device for two-stage dialing for audio and video communication based on IMS according to an embodiment of the present disclosure.

### DETAILED DESCRIPTION OF EMBODIMENTS

The embodiments of the present disclosure are described in detail below in conjunction with the accompanying drawings, in which the same or similar reference numerals indicate the same or similar elements or elements with the same or similar functions. The embodiments described below with reference to the accompanying drawings are exemplary, which is only intended to illustrate the present invention, and cannot be construed as limiting the scope of the present disclosure.

For those skilled in the art, it should be understood that, unless specified, singular forms “a”, “an”, “said” and “the” used herein may also be plural forms. It should be further understood that the term “comprising” used in the specification of the present disclosure refers to the presence of the described features, integers, steps, operations, elements and/or components, but does not exclude the presence or addition of one or more other features, integers, steps, operations, elements, components, and/or combinations thereof. It should be understood that when an element is “connected” or “coupled” to another element, they can be directly connected or coupled, or connected or coupled via an intervening element. In addition, “connected” or “coupled” used herein may result in wireless connection or wireless coupling. The term “and/or” as used herein includes any one of listed items and combinations thereof. It can understood by those skilled in the art that, unless otherwise defined, all terms (including technical terms and scientific terms) used herein have the same meanings as commonly understood by those of ordinary skill in the art to which the present disclosure belongs. It should be understood that terms such as those defined in general dictionaries should be understood to have a meaning consistent with the meaning in the context of the prior art, and unless specified herein, such terms will not be interpreted in an idealized or overly formal meaning.

For those skilled in the art, it should be understood that the terms “terminal” and “terminal equipment” used herein include both equipment with a wireless signal receiver which is not capable of transmitting signals and equipment with a receiver and a transmitter. The equipment with the receiver and the transmitter is capable of performing two-way communication in a two-way communication link. Such equipment may include: cellular or other communication equipment, which has a single-line display or multi-line display or cellular or other communication equipment without a multi-line display; PCS (Personal Communications Service), which can combine voice and data processing, fax and/or data communication; PDA (Personal Digital Assistant), which may include a radio frequency receiver, a pager, Internet/Intranet access, a web browser, a notepad, a calendar and/or a GPS (Global Positioning System) receiver; a conventional laptop and/or a palmtop computer or other devices, which has and/or includes a radio frequency receiver. The “terminal” and “terminal equipment” used herein may be portable, transportable, installed in vehicles (aircrafts, marine vehicles and/or land vehicles), or suitable and/or configured to be locally operated, and/or running on the earth and/or any other location in space in a distributed form. The “terminal” and “terminal device” used herein may also be communication terminals, internet terminals, music/video playback terminals, for example, PDAs, MIDs (Mobile Internet Devices) and/or mobile phones with music/video playback functions, or devices such as smart TVs and set-top boxes.

Specifically, referring to FIG. 1, this embodiment provides a method for two-stage dialing for audio and video communications based on IMS, including the following steps.

S1100) A call request sent from a user terminal is obtained, where the call request includes a target number that the user terminal dials based on the IMS.

During implementation, the IMS obtains the call request sent from the user terminal which includes Webrtc clients or IMS communication clients, such as a PC, mobile phone software, or IMS terminal equipment. In this embodiment, the disclosed method is applied to communication hotlines. When the user is handling business or needs professional consultation, the hotline number can be dialed using the user terminal. The hotline number is dialed based on the IMS communication standard, and a call center module of the IMS is provided. The hotline number is assigned by the IMS. The user dials the number which is assigned to the call center module by the IMS through instant messaging or the IMS communication client.

S1200) A communications link between the user terminal and the IMS is established based on the target number, and a preset operation navigation prompt is sent to the user terminal.

The IMS establishes a communications link with the user terminal based on the target number to realize the first dialing. Since various questions and services are involved, the preset operation navigation prompt can be sent to the user terminal, and the user terminal shows the operation navigation prompt. In the case that the user needs to consult about bank loan-related services, the user dials the bank's hotline number using a mobile phone. After the call is answered, the IMS sends the preset operation navigation prompt to the user terminal. For example, the operation navigation prompt includes the deposit card service, the credit card service, the branch service and the loan service. These services are displayed at the user terminal in a form of broadcast or text, which enables the user to perform the two-stage dialing according to the displayed operation navigation prompt.

S1300) Service confirmation information of the two-stage dialing fed back by the user terminal based on the operation navigation prompt is received, and the audio and video communications are established between the IMS and the user terminal according to the service confirmation information.

The IMS receives the service confirmation information fed back by the user terminal, where the service confirmation information is the confirmation information fed back by the user terminal for the two-stage dialing according to the operation navigation prompt. In case that the method for the two-stage dialing for audio and video communications is applied to the hotline system of the bank, when the user needs to consult bank loan related services, the user dials the hotline number of the bank using an IMS communication client such as a mobile phone. The IMS sends the preset operation navigation prompt to the mobile phone of users, and the operation navigation prompt is broadcast through voice broadcast. The user selects the loan service, and the IMS receives the service confirmation information from the user's mobile phone about the selection of the loan service. Based on the establishment of the two-stage dialing communication, a video or message communication between the user's mobile phone and the hotline answerer is established, so that the hotline answerer provides the user with corresponding visualized services, which facilitates the video communication and message interaction between the user and the hotline answerer.

In the technical solution of the present disclosure, the call request sent from the user terminal is obtained, where the call request includes the target number that the user terminal dials at the user terminal in the IMS, and the target number is allocated by the IMS. The communications link between the user terminal and the IMS is established based on the target number. The operation navigation prompt is sent to the user terminal, and the user terminal guide the user to perform the two-stage dialing, and the service confirmation information of the two-stage dialing fed back from the user terminal according to the operation navigation prompt is received, so as to confirm the service selected by the user. An audio and video communication between the IMS and the user terminal is established based on the service confirmation information, so that the video or message communication is realized between the IMS and the user terminal based on the two-stage dialing, which effectively solves the problem that face-to-face communication is hard to be realized in online service.

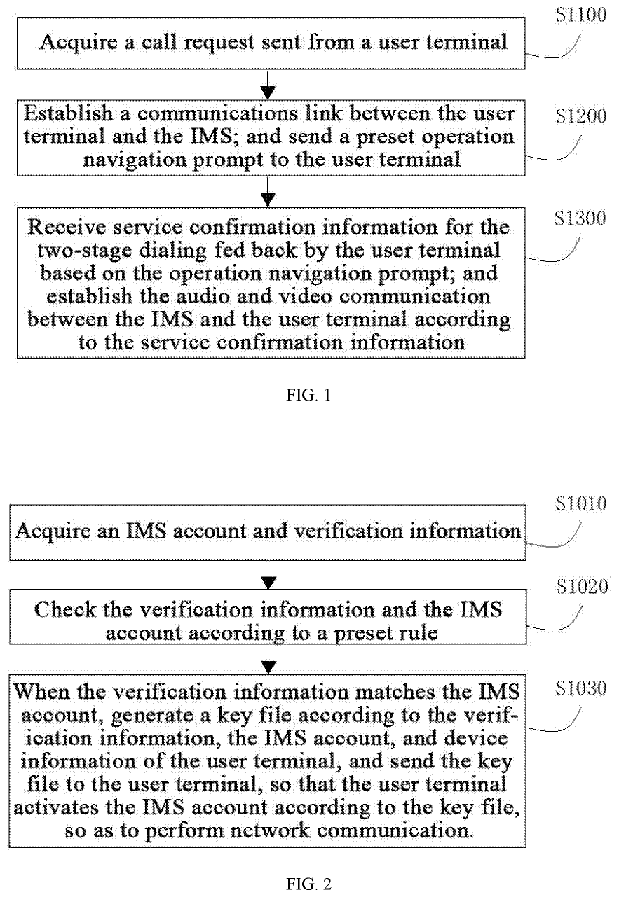

In an embodiment, referring to FIG. 2, the method further includes the following steps.

S1010) An IMS account and verification information of the user terminal are obtained.

During implementation, the IMS account of the user terminal is obtained from an IMS account list. When the user terminal is a computer, the computer obtains the IMS account corresponding to a contract number of the computer. The contract number is the code stipulated by the computer manufacturer and the IMS company. The verification information includes user's identity information and user password information. The IMS receives the IMS account, the user's identity information and the user password information sent from the user terminal.

S1020) The verification information and the IMS account are checked according to a preset rule.

The preset rule is to check the verification information according to pre-stored information. If the verification information is the same as the pre-stored information, the verification is passed; otherwise, the verification fails.

S1030) When the verification information matches the IMS account, a key file is generated according to the verification information, the IMS account, and device information of the user terminal, and is sent to the user terminal, so that the user terminal activates the IMS account to perform network communication according to the key file.

During implementation, when the user terminal is a mobile phone, the device information of the user terminal includes software ID information, hardware information, and the geographic location information of the mobile phone. The software ID information of the mobile phone includes IP address and domain name of the mobile phone, and the hardware information of the mobile phone includes IMEI, MEID or hard disk.

When the user terminal is a computer, the device information of the user terminal includes software ID information and geographic location information of the computer, where the software ID information includes IP address and domain name of the computer.

When the user terminal receives the key file, the user terminal parses the key file to obtain the IMS account, IMS account password, software ID information, hardware information, and geographic location information. For example, when the user terminal is a mobile phone, the software ID information, the hardware information and the geographic location information of the mobile phone are obtained. The user terminal may be other electronic devices, such as a computer. In the case that the user terminal is a computer, the software ID information, the hardware information, and the geographic location information of the computer are obtained, and the obtained IMS account, IMS account password, software ID information, hardware information, and geographic location information are added to the corresponding software to activate the IMS account and ensure that the user terminal performs network communication through the activated IMS account.

In an embodiment, referring to FIG. 3, the method further includes: S1040) A hotline number acquisition request sent from the user terminal through the IMS account is acquired.

During implementation, the user needs to query the corresponding hotline number. For example, when there is a need to inquire about legal issues, the user can dial a predetermined number first to query the hotline number that can provide legal services.

S1050) A preset hotline number list is sent to the user terminal according to the hotline number acquisition request, where the hotline number list includes at least one target number.

The IMS receives the hotline number acquisition request sent from the user terminal, and sends the preset hotline number list to the user terminal according to the hotline number acquisition request. The preset hotline number list includes multiple hotline numbers to provide users with convenient search service for hotline numbers.

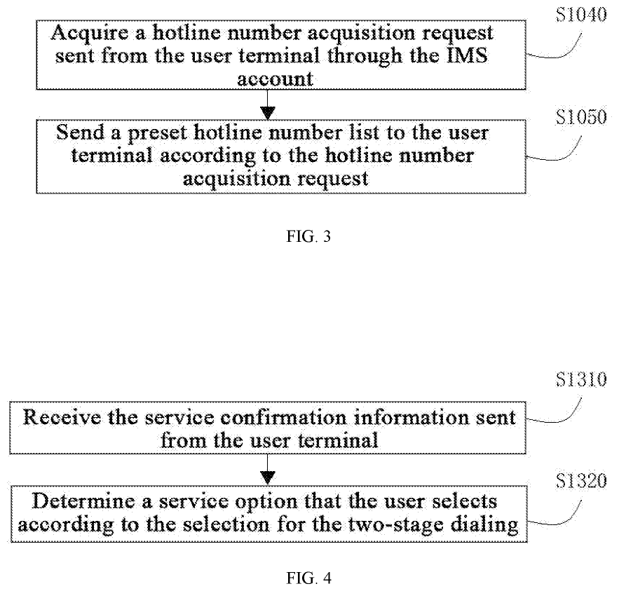

In an embodiment, referring to FIG. 4, the step of receiving service confirmation information of the two-stage dialing fed back by the user terminal based on the operation navigation prompt includes the following steps.

1310) The service confirmation information sent from the user terminal is received, where the service confirmation information includes selection for the two-stage dialing according to the operation navigation prompt displayed on the user terminal.

The user terminal displays the operation navigation prompt to the user in a form such as voice broadcast. The user makes a selection according to the operation navigation prompt, and the user terminal generates the service confirmation information according to the selection of the user.

1320) A service option selected by the user according to the selection is confirmed.

After the SMI receives the service confirmation information sent from the user terminal, the service confirmation information is parsed to acquire the service option selected by the user. For example, in the case that the user needs to consult about bank loan related services, the operation navigation prompt sent from the SMI to the user terminal includes a first service, a second service, and a third service. When the user selects the first service based on the operation navigation prompt, the SMI receives the service confirmation information, sent from the user terminal, that the user selects the first service, so as to confirm the user's selection of the first service, and establish a video or message communication with the hotline answerer corresponding to the first service. During implementation, a communication interface corresponding to the service option is called, and the audio and video communication with the user terminal is established based on the communication interface, so that the hotline answerer can provide the user with the visualized service.

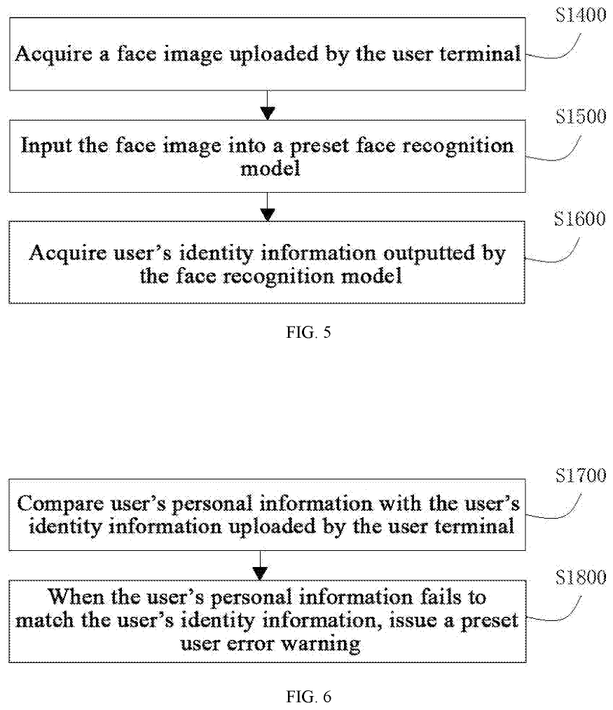

In some embodiments, referring to FIG. 5, the method further includes the following steps.

S1400) A face image uploaded by the user terminal is acquired, where the face image is an image of a user's face collected by the user terminal.

After establishing the audio and video communication with the user terminal, the SMI can also perform face recognition, and the face image of the user is collected by the user terminal such as a smart phone having a front camera or a rear camera, and the face image of the user is acquired by taking photos or videos. In the case that the face image of the user is obtained by taking a video, the camera on the smartphone captures the user to obtain the target video. The IMS processes the target video through video processing software (such as OpenCV), and the target video is divided into multiple frames of pictures, and face images are extracted from the target video with a regular interval. For example, target pictures are extracted from the target video at a rate of 0.5 seconds, and one target picture is randomly selected from the obtained target pictures as the face image of the user. The extraction speed is not limited herein, which can be adaptively adjusted according to the different scenarios. A shorter collection time is required when the IMS has a stronger processing capability and there is a higher tracking accuracy requirement until the collection time corresponds to the frequency at which the camera collects images. However, 1s is the maximum time interval for collection. One frame of the target video may be selected as the face image of the user.

S1500) The face image is inputted into a preset face recognition model, where the face recognition model is a neural network model trained to convergence.

The face recognition model is a tool preset by the IMS for recognizing face images. During implementation, LSTM network (Long Short-Term Memory) may be used as the neural network model. The discarding or adding of information is controlled through “gate” in the LSTM network, so as to achieve the function of forgetting or memory. The “gate”, consisting of a sigmoid (S-shaped growth curve) function and a dot product operation, is a structure that allows information to pass selectively. The output value of the sigmoid function is in the interval [0,1], where 0 means that the information is completely discarded, and 1 means that the information is completely passed. The neural network model trained to convergence has a classifier that can recognize face images. The face recognition model includes the neural network model having N+1 classifiers, where N is a positive integer.

Specifically, the face images are inputted into the preset face recognition model to obtain a classification result of the face images in the classifier. The classification result includes identity information classifications of the face image and confidences of the identity information classifications. After the face image is classified by the face recognition model, the face image is classified into more than one identity information classifications and the percentages of the face image in the identity information classification is obtained, and such percentage is named as the confidence of the identity information classification. Only information of one identity corresponding to the face image is required, and therefore, different identity information classifications directed to the same face image are compared in terms of the confidence. For example, the confidence that the face image is classified into an identity information classification of A is 0.95, and the confidence that the face image is classified into an identity information classification of B is 0.65.

Then, such confidence is compared with a preset first threshold. When the confidence is greater than the preset first threshold, the classification result represented by the confidence corresponds to the user's identity information. Generally, the preset first threshold is set to a value between 0.9 and 1. The emotional information with a confidence greater than the first threshold is selected as the final classification result, that is, the user's identity information represented by the confidence is confirmed. For example, when the preset first threshold is 0.9, and the confidence that the face image of the user is classified into the user's identity information of A, the user's identity information represented by the face image is the user's identity information of A due to 0.95>0.9.

S1600) The user's identity information outputted by the face recognition model is acquired.

The face recognition model outputs the user's identity information after recognizing the face image of the user. The confidence of the identity information classification of the face image outputted by the face recognition model is outputted by inputting the face image into the preset face recognition model. When the confidence is greater than the preset first threshold, the classification result represented by the confidence is the user's identity information, which improves the accuracy of identifying the identity information classification of the face image.

In some embodiments, referring to FIG. 6, the method further includes the following steps.

S1700) User's personal information is compared to the user's identity information uploaded by the user terminal.

S1800) When the user's personal information fails to match the user's identity information, a preset user error warning is issued.

The system receives the user's identity information uploaded by the user terminal and compares the user's identity information with the user's personal information. When the user's personal information does not match the user's identity information, a preset user error warning is issued. The hotline answerer is reminded of paying attention to whether the user account is abnormal or illegally occupied, which improves the security of the account.

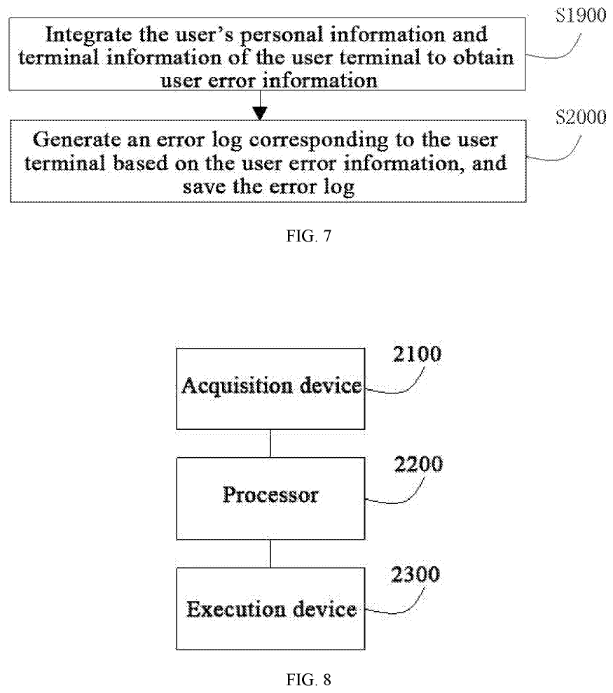

Optionally, referring to FIG. 7, the method further includes the following steps.

S1900) The user's personal information and terminal information at the user terminal are integrated to generate user error information.

S2000) An error log corresponding to the user terminal is generated and saved according to the user error information.

Specifically, when the user's personal information does not match the user's identity information, the system integrates the user's personal information and the terminal information of the user terminal to generate the user error information. The terminal information includes software ID information, hardware information, and geographic location information of the user terminal. The IMS generates an error log based on the user error information, so as to facilitate system maintenance and improvement based on the error log.

As shown in FIG. 8, the present application further provides a device for two-stage dialing for audio and video communications based on IMS, including:

an acquisition device 2100, which is configured to acquire a call request sent from a user terminal, where the call request includes a target number that the user terminal dials based on the IMS;

a processor 2200, which is configured to establish a communications link with the user terminal and send a preset operation navigation prompt to the user terminal;

an execution device 2300, which is configured to receive service confirmation information for the two-stage dialing returned from the user terminal according to the operation navigation prompt, and establish an audio and video communication with the user terminal according to the service confirmation information.

In this embodiment, the call request sent from the user terminal is acquired, where the call request includes the target number that the user terminal dials on the IMS, and the target number is allocated by the IMS. The communication is established between the user terminal and the IMS according to the target number. The operation navigation prompt is sent to the user terminal, and the user terminal guides the user to perform the two-stage dialing, and the service confirmation information of the two-stage dialing fed back from the user terminal according to the operation navigation prompt is received, so as to confirm the service selected by the user. An audio and video communication is established between the IMS and the user terminal based on the service confirmation information, so that the video or message communication can be realized between the IMS and the user terminal based on the two-stage dialing, which effectively solves the problem that face-to-face communication is hard to realize in online service.

It should be understood that, although the process has been described to occur according to the order of sequence, such process may be practiced with the described steps performed in an order other than the order described herein. It further should be understood that certain steps may be performed simultaneously, that other steps could be added, or that certain steps described herein could be omitted. In other words, the descriptions of processes herein are provided for the purpose of illustrating certain embodiments, and should in no way be construed so as to limit the present invention.

The above embodiments are only some embodiments of the present disclosure. It should be noted that improvements and modifications can be made by those of ordinary skill in the art without departing from the principle of the present invention, and these improvements and modifications should also be regarded as falling within the protection scope of the present disclosure.

What is claimed is:

1. A method for two-stage dialing for audio and video communications based on IMS, comprising:
acquiring a call request sent from a user terminal; wherein the call request comprises a target number that the user terminal dials based on the IMS;
establishing a communications link between the user terminal and the IMS; and sending a preset operation navigation prompt to the user terminal; and
receiving service confirmation information for the two-stage dialing fed back by the user terminal based on the operation navigation prompt; and establishing the audio and video communication between the IMS and the user terminal according to the service confirmation information.

2. The method of claim 1, further comprising:
acquiring an IMS account and verification information;
checking the verification information and the IMS account according to a preset rule;
when the verification information matches the IMS account, generating a key file according to the verification information, the IMS account, and device information of the user terminal, and sending the key file to the user terminal, so that the user terminal activates the IMS account according to the key file, so as to perform network communication.

3. The method of claim 2, further comprising:
acquiring a hotline number acquisition request sent from the user terminal through the IMS account; and
sending a preset hotline number list to the user terminal according to the hotline number acquisition request, wherein the hotline number list comprises at least one target number.

4. The method of claim 1, wherein the step of sending the preset operation navigation prompt to the user terminal comprises:
determining a service type corresponding to the target number; and
searching the operation navigation prompt corresponding to the service type in a preset service navigation database, and sending the operation navigation prompt to the user terminal.

5. The method of claim 1, wherein the step of receiving service confirmation information for the two-stage dialing fed back by the user terminal based on the operation navigation prompt comprises:
receiving the service confirmation information sent from the user terminal, wherein the service confirmation information comprises selection for the two-stage dialing that a user makes based on the operation navigation prompt shown in the user terminal; and
determining a service option that the user selects according to the selection for the two-stage dialing.

6. The method of claim 5, wherein the step of establishing the audio and video communication between the IMS and the user terminal according to the service confirmation information comprises:
calling a communication interface corresponding to the service option; and
establishing the audio and video communication between the IMS and the user terminal based on the communication interface.

7. The method of claim 1, further comprising:
acquiring a face image uploaded by the user terminal, wherein the face image is an image of a user's face collected by the user terminal;
inputting the face image into a preset face recognition model, wherein the face recognition model is a neural network model trained to convergence; and
acquiring user's identity information outputted by the face recognition model.

8. The method of claim 7, further comprising:
comparing user's personal information with the user's identity information uploaded by the user terminal; and
when the user's personal information fails to match the user's identity information, issuing a preset user error warning.

9. The method of claim 8, further comprising:
integrating the user's personal information and terminal information of the user terminal to obtain user error information; and
generating an error log corresponding to the user terminal based on the user error information, and saving the error log.

10. A device for two-stage dialing for audio and video communications based on IMS, comprising:
an acquisition device, which is configured to acquire a call request sent from a user terminal, wherein the call request includes a target number that the user terminal dials based on the IMS;
a processor, which is configured to establish a communication with the user terminal and send a preset operation navigation prompt to the user terminal; and
an execution device, which is configured to receive service confirmation information for the two-stage dialing returned from the user terminal according to the operation navigation prompt, and establish audio and video communications with the user terminal according to the service confirmation information.
